(19) United States
(12) Patent Application Publication
(10) Pub. No.: US 2009/0188151 A1
(43) Pub. Date: Jul. 30, 2009

(54) Sliding fishing float and sinker

(76) Inventor: R. Mark Bartholomew, (US)

Correspondence Address: R. Mark Bartholomew, 1068 West 1050 North, Mapleton, UT, 84664, US

(21) Appl. No.: 12/011,132

(22) Filed: Jan. 25, 2008

(51) Int. Cl. A01K 93/00; A01K 95/00

(52) U.S. Cl. 43/44.91; 43/44.87; 43/43.14

(57) ABSTRACT

The multi-function float/sinker of a plastic material provides either a quick attachment or removal from the fishing line 37 without the need for cutting the fishing line 37. The four-piece device has a hollow body 13 that is adapted to receive water or other material that has an overall specific gravity weight greater than one. It can serve as a float, or as a casting bubble or as a sinker. It has a water-tight snap-on cover 21 for the cavity 33 and on the opposite side of body 13 an insert 25 placed in slot 12, the two acting together form a passageway for the fishing line 37 or for the retainer 41.

### BACKGROUND

1. Field of Invention

This invention relates to a casting float or bobber/sinker that can either slide freely on the fishing line or can be attached in a fixed position.

2. Description of Prior Art

Many fishing float/sinkers devices have been invented in an attempt to solve some of the fisher's problems in regards to making a float/sinker that can be used in several ways to accommodate the needs of the fisher without his having to use multiple numbers of sinkers and floats. A superior float/sinker should include the following qualifications:
(a) be compact
(b) protect fishing line
(c) can change buoyancy
(d) be light-weight
(e) have few parts
(f) saves time
(g) easy to manipulate
(h) free of moving parts
(i) be cost-effective
(j) be versatile
(j) be durable

These prerequisites have been only partially addressed to date in manufacturing of float/sinkers even though many types of these devices have been proposed over the years. Accordingly, some of the prior art are detailed below along with objections to each.
U.S. Pat. No. 2,693,049 to Atton in August 1949 has a central passageway that requires fishing line to be cut and threaded through. Predetermined weight
U.S. Pat. No. 2,726,474 to Soskice in December 1955 must be put on line in proper direction for casting or the plug becomes loose allowing water to go in or out of the body and thus changing weight of float. Line is tied to outside of float. It is not desirable to tie knots in fishing line.
U.S. Pat. No. 2,827,731 to Haynes in March 1958, the fishing line must be cut in order to thread line through central tube in order to attach Reverse operation to remove float to put water in cavity. Operation must be done under water all the time keeping the tube in correct position in order to keep water from escaping.
U.S. Pat. No. 3,273,278 to Lynch in September 1966 is objectionable because floats and sinkers would be of different sizes to obtain desirable weight. It would necessarily need to be made of suitable material to make the change.
U.S. Pat. No. 12,060 to Hoard in December 1854. The fishing line being threaded through the central portion of the float/sinker has to be cut and retied. There is only a small opening at ends of float/sinker to receive material for changing weight and buoyancy.
U.S. Pat. No. 3,736,690 to Witkowski in June 1973. The fishing line must be cut and threaded through central portion of float and tied, then, cut again to remove fishing line. Weights similar to a steel washer are used to change the weight of the float/sinker. These changes are very time-consuming.
U.S. Pat. No. 4,202,128 to Hill in May 1980 has adjustable parts that are recommended to be lubricated, a practice which would attract grit and dirt to an oily part. Expensive to manufacture and also needs a tool to make adjustments.
U.S. Pat. No. 4,351,128 to Sivertsen in September 1982. The float/sinker is made of various densities of materials thus requiring multiple items which are cost prohibitive to manufacture.
U.S. Pat. No. 6,467,214 to DeFrisco in October 2002 must be assembled on fishing line in proper direction. Has small opening to add or diminish weight. Must be held under water to fill cavity and reposition tapered pin while submerged.

In addition to checking out multiple patents (only a very few had float/sinker combinations), catalogs have been perused related to fishing gear, sporting good stores have been frequented in several states to determine if there is a sliding/float sinker devise which meets the previously mentioned criteria of a fisher. To this date, this inventor has found no such devise.

Objects and Advantages

The objects and advantages of the prior art have been addressed; therefore, several objects and advantages of the present invention are as follows:
(a) to provide a float/sinker that is easy to attach to the fishing line;
(b) to provide a float/sinker that is easy to cast;
(c) to provide a float/sinker that allows an easy change of weight;
(d) to provide a float/sinker that needs no threading through central passageway;
(e) to provide a float/sinker that does not damage fishing line;
(f) to provide a float/sinker that is cost effective, meaning it will be inexpensive to manufacture;
(g) to provide a float sinker that is durable and can be used repeatedly;
(h) to provide a float/sinker that is free from moving parts that may need to be repaired or replaced;
(i) to provide a float/sinker that requires no lubrication that could attract dirt, lint, etc.;
(j) to provide a float/sinker with a cavity to hold additional weights;
(k) to provide a float/sinker that is easy to load or unload different sized weights, weights that can be changed without removing fishing line;
(l) to provide a float/sinker that slides freely on the fishing line or conversely provides positive attachment if desired.
(m) to provide a float/sinker with a means of quickly attaching or detaching a hook, lure, or fly from the float/sinker.

### DRAWING FIGURES

FIG. 1 shows a completely assembled float with fishing line in passage-way.

FIG. 2 shows a vertical exploded perspective view.

FIG. 3-A shows a vertical view of body without insert

FIG. 3-B shows a vertical side view of body with cover (FIG. 3-D) snapped in place.

FIG. 3-C shows an end view of body with cover (FIG. 3-D) snapped in place.

FIG. 3-D shows an inside vertical view of cover.

FIG. 3-E shows a vertical view of body cavity with wall of slot cavity protruding into body.

FIG. 3-F shows a cross-sectional detail taken substantially on plane passing along line 3F-3F in( FIG. 3-D).

FIG. 3-G shows a cross-sectional detail taken substantially on a plane passing along line 3G-3G in (FIG. 3-E).

FIG. 4-A shows a vertical top view of insert.

FIG. 4-B shows a vertical side view of insert.

FIG. 4-C shows a vertical bottom view of insert.

FIG. 4-D shows an end view of insert, both ends being identical.

FIG. 5 shows a vertical sectional view of float and fishing line.

FIG. 6-A shows a vertical view of float/sinker with retainer (FIG. 6-B) in place.

FIG. 6-B shows a vertical view of retainer with identical rings at each end.

Reference Numerals in Drawings

| | | | | | |
|---|---|---|---|---|---|
| 11 | wall of notch | 12 | slot | 13 | body |
| 14 | notch base | 15 | female snap | 17 | lip |
| 18 | rib on cover | 19 | shank | 20 | inner shoulder |
| 21 | cover (inside) | 22 | cover | 23 | appendage |
| 24 | appendage wall | 25 | insert | 26 | male snap |
| 27 | slot | 28 | rib in cavity | 29 | appendage (bottom) |
| 33 | cavity | 34 | bearing surface | 36 | wall for slot |
| 37 | fishing line | 40 | ring | 41 | retainer |

### DESCRIPTION—1 THROUGH 6B

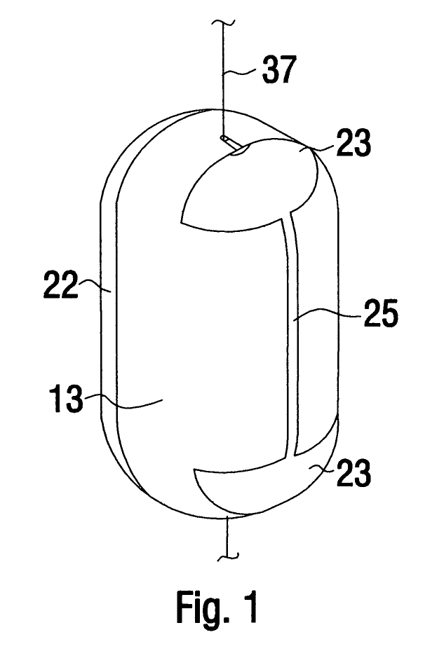

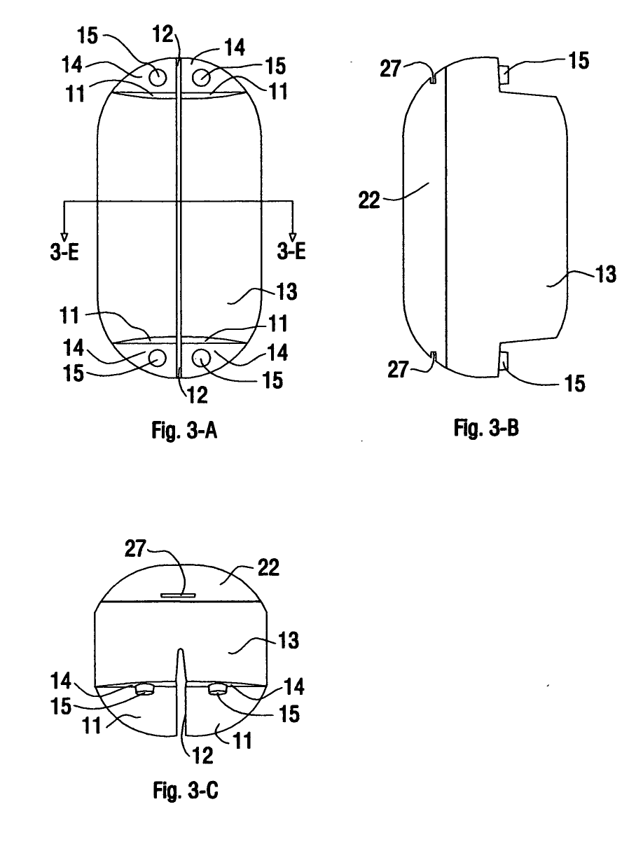

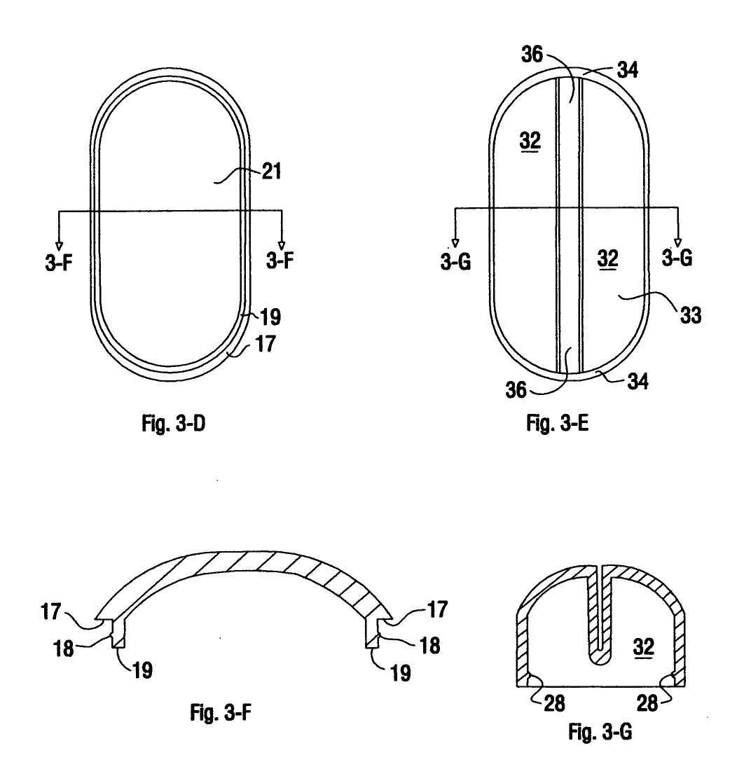

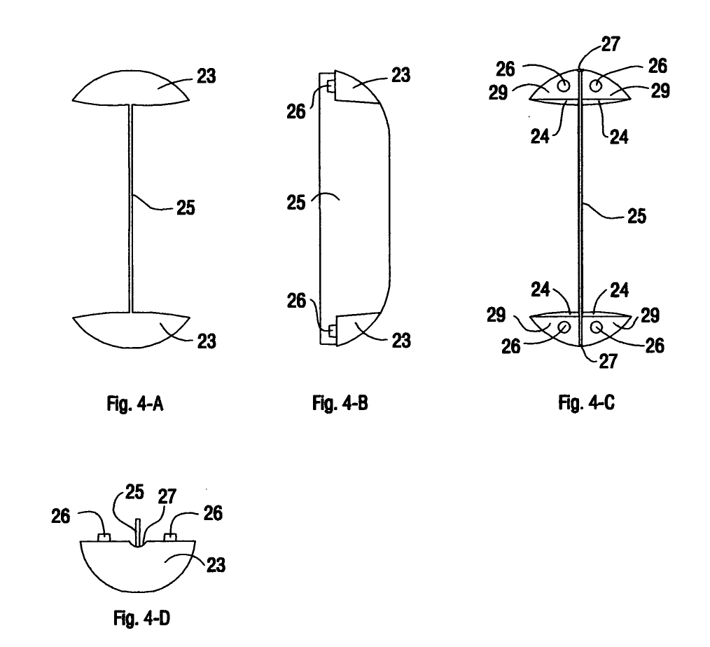

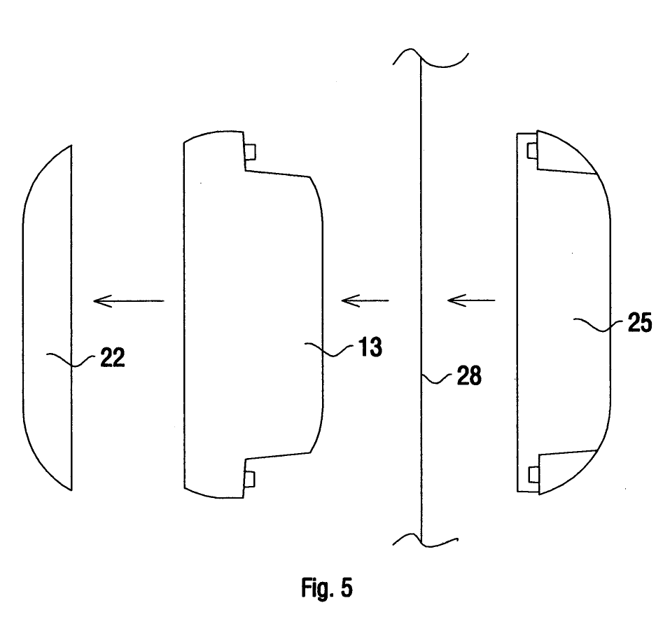

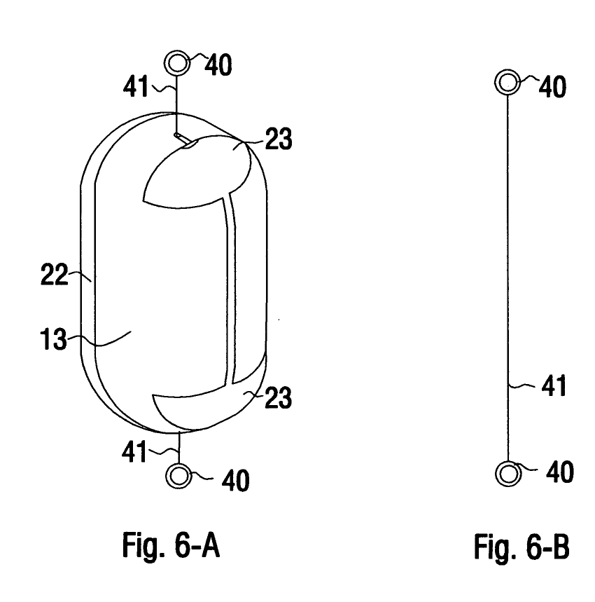

A typical embodiment of the current sliding float/sinker is illustrated in FIGS. 1-6B, the float/sinker comprising four separate components. The main component is the hollow body 13 FIG. 5 (vertical view) and FIG. 3E (vertical view). The three remaining components are the snap-on cover 22 FIG. 3D (vertical view), the cover 22 being shown snapped in place in FIG. 3B. (side vertical view). Another component, the insert 25 is shown in FIG. 4A (top vertical view), FIG. 4B (vertical side view), FIG. 4C (vertical bottom view), and in FIG. 4D (end view). The last component, the retainer 41, is shown in FIG. 6B ((vertical view) with attachment ring 40 at each end. FIG. 6A (vertical view) shows retainer 41 in place in body 13 of float

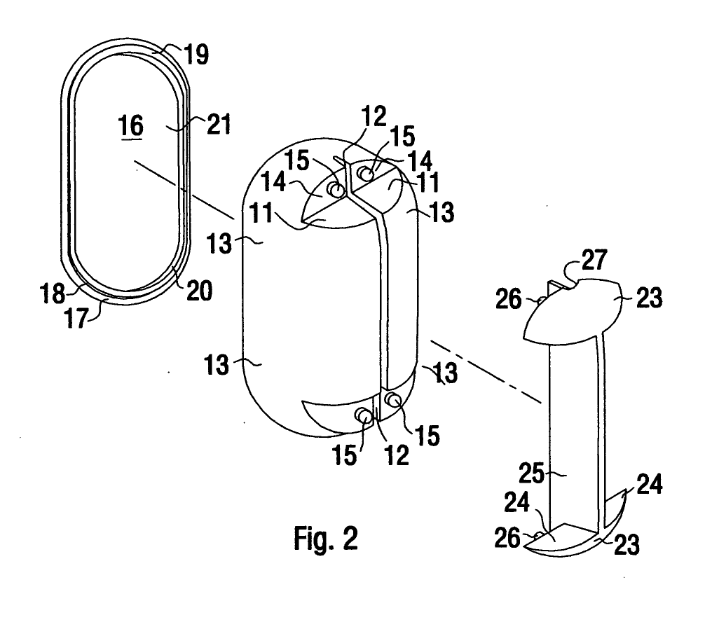

FIG. 1 shows the sliding float/sinker fully assembled with the insert 25 in place creating a passageway for fishing line 37 with cover 22 snapped in place. FIG. 2 shows three main parts in relation to each part: the snap on cover 22 with shank 19 that shows rib 18 and matching rib 28 in cavity 33. The whole body is preferably oblong but is not limited to that shape. It is of a dimension that serves the desires and preferences of the fisher.

Operation—1 through 6B

The manner of using the float/sinker is both simple and easy as made apparent when viewing FIGS. 1, 2, 3, 5, FIGS. 6A, and FIG. 6B. A cover 22 (FIG. 1) is removed from opening of cavity 33 (3E). Added weight of chosen material is placed within the open cavity 33. The cover 22 (FIG. 5) is then replaced. The cover 22 is held in place by the meeting of rib 18 on shank 19 and on complimentary rib 28 (FIG. 3G) inside of cavity 33. The act of snapping the cover in place keeps the added weight in place. Next the fishing line 37 (FIG. 5) is placed in slot 12 (FIG. 2) followed by placing the insert 25 (FIG. 2) into same slot 12. Then the appendage 23 (FIG. 2) at each end of the insert 25 is fitted into the notch base 14 (FIG. 2) with opposing snaps 15 and 26 (FIG. 2) pressed in place at each end, thus creating a passageway for fishing line 37 and for the float/sinker (FIG. 1) to freely slide on fishing line.

To give positive or fixed attachment to fishing line 37 and leader, not shown, and provide rapid, secure and easy attachment of the float/sinker (FIG. 6A) to fishing line 37 FIG. 6A), place the retainer 41 (FIG. 6B) with rings 40 (FIG. 6B) on opposing ends, into slot 12 (FIG. 2) of body 13 (FIG. 2) Retainer 41 (FIG. 6B) is secured by snapping insert 25 (FIG. 2) into slot 12 (FIG. 2) in a fixed position. To easily remove the cover 22 (FIG. 1) use the small slot 27) on each end of cover 22 for finger nail removal. Likewise, on the insert 25 (FIG. 2), there is a small slot 27 (FIG. 2) on each end of appendage 23 (FIG. 2) for finger nail removal.

There can be round objects such as marbles, not shown, that can be placed in float cavity 33. When these objects move from the motion of the water, there is a vibration and noise that can attract the fish.

1. A sliding float/sinker embodying four separate parts comprising (1) a body with a cavity for holding water or other material for the purpose of increasing its weight, the body having (2) a snap-on cover giving access to cavity wherein weight can be added or removed, the body having (3) an insert that when placed in slot extending the full length and to the axis of float/sinker makes a passageway for fishing line where float can slide freely on fishing line, and the float/sinker having (4) a retainer placed in the passageway with insert in place in slot of the float/sinker extending the full length of the float/sinker keeping it in a fixed position on fishing line.

2. The float/sinker in claim 1 wherein said body may be constructed from a variety of commercially available plastic materials similar to polyethylene plastic.

3. The float/sinker in claim 1 wherein said body is of a size compatible to the needs of the fisher.

4. The float/sinker in claim 1 wherein said float/sinker preferably is formed in an elongated shape.

5. The float/sinker in claim 1 wherein said entire body can be formed in an oval, a rectangular, or another shape being determined by the needs of the fisher.

6. The float/sinker in claim 1 wherein the main portion of float/sinker is hollow.

7. The float/sinker in claim 1 wherein said both ends of float/sinker are identical.

8. The float/sinker in claim 1 wherein float/sinker can be placed on fishing line in either direction.

9. The float/sinker in claim 1 wherein float/sinker can be attached to retainer in either direction.

10. The float/sinker in claim 1 wherein the float/sinker can be used as a bubble, as a float, as a sinker, or as a casting float or sinker.

11. The float/sinker in claim 1 wherein float/sinker can be either attached or removed from fishing line without cutting the line.

12. The retainer in claim 1 wherein retainer can be formed from either a plastic or from a metal wire.

13. The retainer in claim 1 whereas retainer has two rings of the same size, one ring on each of the opposite ends for the purpose of attaching fishing line and fishing leader.

14. The float/sinker in claim 1 wherein float/sinker has a slot extending the full length and to the center axis of float/sinker.

15. The float/sinker in claim 1 having an insert with appendages at both ends, and having been placed in slot that extends the full length of body, said appendages of insert both merge with base of notch to determine the space of slot to allow passage of fishing line.

16. The float/sinker in claim 1 has male snaps on bottom side of appendage to match with female snaps in notch base of body for the purpose of holding the retainer insert in slot body.

17. The float/sinker in claim 1 wherein the opening of cavity is designed with a rib which meets with a similar rib designed on snap-on cover, both ribs together forming a retainer for the cover.

18. A sliding float/sinker embodying three separate parts comprising (1) a body with cavity for holding water or other material for the purpose of increasing its weight, the body having (2) a snap-on cover giving access to cavity, the body having a slot to receive (3) the insert, said insert forming a passageway for fishing line where float/sinker can slide freely on the fishing line.

19. The body and the cover in claim 18 may have matching threads, not shown in drawings, to facilitate the opening and closing of the cavity.

20. A float/sinker embodying three separate parts comprising (1) a hollow body having a cavity for holding water or other material for the purpose of increasing or decreasing the weight of the float/sinker, (2) an insert to make a passageway for fishing line, and (3) a retainer to keep float/sinker in a fixed mode on fishing line.
